(19) United States
(12) Patent Application Publication
(10) Pub. No.: US 2007/0211480 A1
(43) Pub. Date: Sep. 13, 2007

(54) Projecting device and lamp-supporting structure thereof

(75) Inventors: Sheng-Chang Lu, Magong City (TW); Chang-Chien Li, Taoyuan City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/714,872

(22) Filed: Mar. 7, 2007

(30) Foreign Application Priority Data
Mar. 8, 2006 (TW) 95107806

(51) Int. Cl. F21V 19/00

(52) U.S. Cl. 362/382

(57) ABSTRACT

A projecting device includes a lamp, a supporting structure and a fan. The supporting structure includes a supporting portion and a flange. The supporting portion having a first chamber covers the lamp. The supporting portion has a first sidewall and an opposite second sidewall, and an entry and an exit are respectively disposed thereon. The flange extends from the supporting portion and surrounds a second chamber. The first and second chambers are connected to each other to form a space inside the supporting structure. The fan is for generating airflow running through the entry and the exit. The supporting structure further has an aperture for communicating the space and outside of the supporting structure.

This application claims the benefit of Taiwan application Serial No. 95107806, filed Mar. 8, 2006, the subject matter of which is incorporated herein by reference.

### BACKGROUND OF THE INVENTION

1. Field of the Invention

The invention relates in general to a projecting device, and more particularly to a projecting device and a supporting structure thereof.

2. Description of the Related Art

The temperature of the lamp in a projector or a projection television is really high when the lamp operates. As a result, the lamp becomes the largest heat source in the whole device. Conventionally, polymers are used to be the material of the supporting device of the lamp. However, polymer materials can not endure high temperature and heat. As the wattage of the lamp increases, an extra heat-dissipating device needs to be added for cooling the lamp and supporting the structure.

In another aspect, heat resistant polymers or metal is developed recently to be the material of the supporting structure of the lamp. However, the heat resistant polymers or metal is expensive, which results in high cost of the projecting device.

### SUMMARY OF THE INVENTION

The invention is directed to a projecting device and a lamp-supporting structure thereof with good heat-dissipation ability. Without using the expensive heat resistant material to manufacture the supporting structure, the manufacturing cost is lowered.

According to the present invention, a supporting structure for supporting a lamp is provided. The supporting structure includes a supporting portion and a flange. The supporting portion having a first chamber covers the lamp. The supporting portion has a first sidewall and an opposite second sidewall. An entry and an exit are respectively disposed on the first sidewall and the second sidewall. The flange extends from the supporting portion and surrounds a second chamber. The first chamber and the second chamber are connected to each other to form a space inside the supporting structure. The supporting structure further has an aperture for communicating the space and outside of the supporting structure.

According to the present invention, a projecting device including a lamp, a supporting structure and a fan is provided. The supporting structure includes a supporting portion and a flange. The supporting portion having a first chamber covers the lamp. The supporting portion has a first sidewall and an opposite second sidewall, and an entry and an exit are respectively disposed on the first sidewall and the second sidewall. The flange extending from the supporting portion surrounds a second chamber. The first chamber and the second chamber are connected to each other to form a space inside the supporting structure. The fan is for generating airflow running through the entry and the exit. The supporting structure further has an aperture for communicating the space and outside of the supporting structure.

The invention will become apparent from the following detailed description of the preferred but non-limiting embodiments. The following description is made with reference to the accompanying drawings.

### BRIEF DESCRIPTION OF THE DRAWINGS

FIG. 1 is a three-dimensional view of inner structures of a projecting device according to a preferred embodiment of the invention;

FIG. 2A is an enlarged three-dimensional view of the supporting structure in FIG. 1;

FIG. 2B is a lateral view of the supporting structure in FIG. 1; and

FIG. 3 illustrates the supporting structure of the projecting device according to the preferred embodiment of the invention when the fan operates.

### DETAILED DESCRIPTION OF THE INVENTION

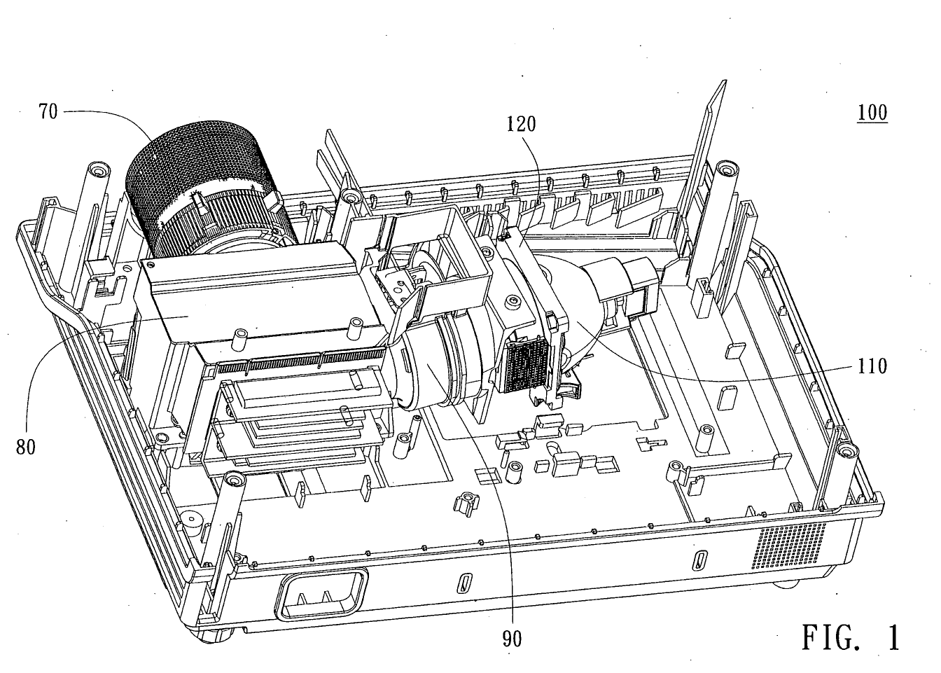

Please referring to FIG. 1, a three-dimensional view of inner structures of a projecting device according to a preferred embodiment of the invention is illustrated in FIG. 1. The projecting device is a projector or a projection television for example. The projecting device 100 of the present embodiment includes at least a lamp 110, a supporting structure 120 and a fan. The supporting structure 120 covers the lamp 11. The fan (not shown in drawings) generates airflow flowing through the inside of the supporting structure, for dissipating heat of the lamp 110. The lamp 110 generates light to enter a light integrator 90. Subsequently, the light enters a light engine 80. Then, an image is projected through a lens 70.

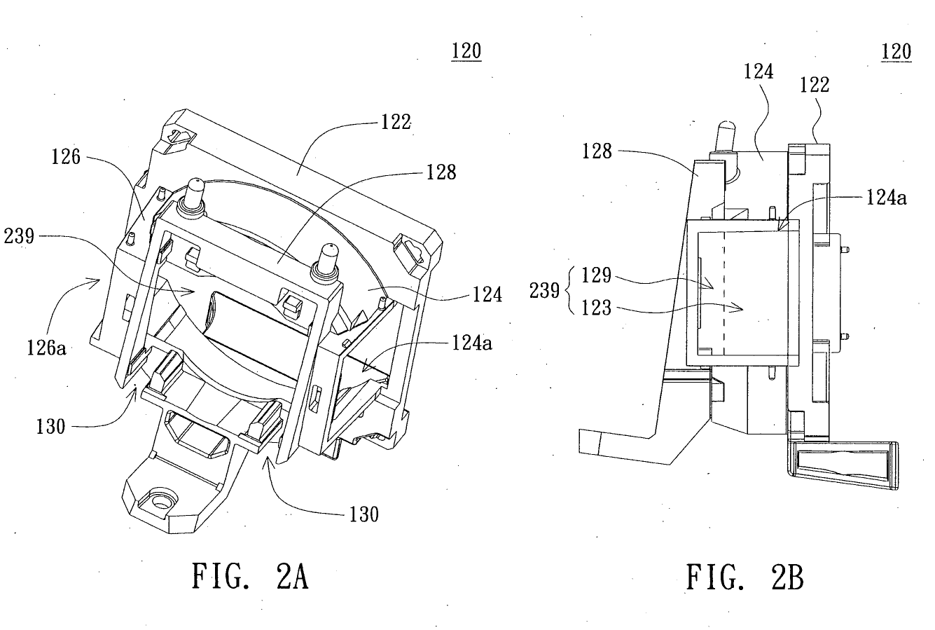

FIG. 2A is an enlarged three-dimensional view of the supporting structure in FIG. 1. FIG. 2B is a lateral view of the supporting structure in FIG. 1. Please referring to FIG. 2A, the supporting structure, 120 includes a supporting portion 122 and a flange 128. The supporting portion 122 is for covering the lamp. The supporting portion 122 has a first sidewall 124 and a second sidewall 126. An entry 124a and an exit 126a are formed on the first sidewall 124 and the second sidewall 126 respectively. The flange 128 extends from the supporting portion 122. The fan is for generating airflow running through the entry 124a and the exit 126a. Please referring to FIG. 2B, a first chamber 123 is formed inside the supporting portion 122. The flange surrounds a second chamber 129. The first chamber 123 and the second chamber 129 are connected to each other to form a space 239 inside the supporting structure 100.

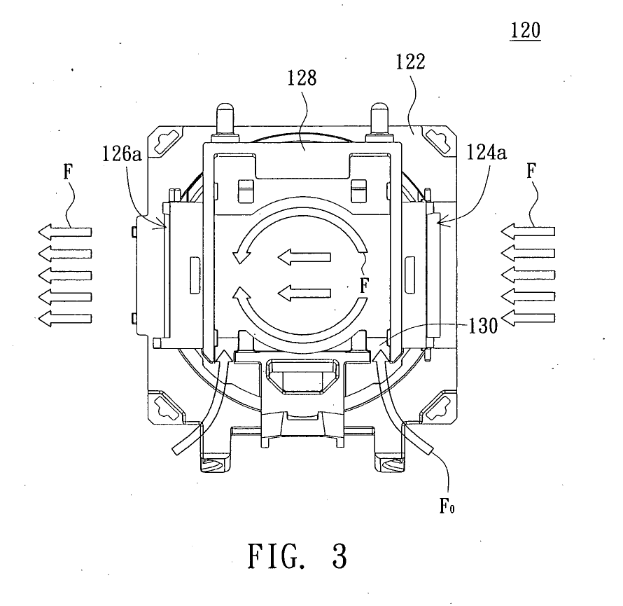

The supporting structure further has an aperture 130 for communicating the space and the outside of the supporting structure, as shown in FIG. 2A. FIG. 3 illustrates the supporting structure of the projecting device according to the preferred embodiment of the invention when the fan operates. When the fan generates airflow, a low pressure zone is formed inside the supporting structure 100, and a relatively high pressure zone is formed outside the supporting area. For example, the fan draws in the air inside the supporting structure 100 to form airflow shown as an arrow F in FIG. 3. Meanwhile, the aperture 130 provides a channel for air to flow through, so that the air F₀ outside the supporting structure 100 naturally flows from the high pressure zone to the low pressure zone inside the supporting structure 100. The aperture 130 dissipates heat by enabling air flow freely.

Preferably, the aperture 130 is located at the flange 128 for communicating the second chamber 129 and the outside of the supporting structure 100, as shown in FIG. 2A. More preferably, the aperture 130 is located on a lower portion of the supporting structure 120.

Anyone who has ordinary skill in the field of the invention can understand that the location of the aperture is not limited to the flange in the drawings. The aperture can be located at the supporting portion for communicating the first chamber and the outside of the supporting structure. In other words, as long as the aperture is formed on the supporting structure and connects the space inside the supporting structure and the outside of the supporting structure, the present invention encompasses all such modifications. For example, the aperture is located at the flange, the supporting portion or across the supporting portion and the flange.

The projecting device and the supporting structure thereof according to the above embodiment of the invention dissipate heat well. Further, because the supporting structure has better cooling ability, there is no need to use heat resistant materials to manufacture the supporting structure. Therefore, the manufacturing cost is lowered.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A supporting structure for supporting a lamp, the supporting structure comprising:
a supporting portion covering the lamp, a first chamber formed inside the supporting portion, the supporting portion having a first sidewall and a second sidewall, an entry and an exit disposed respectively on the first sidewall and the second sidewall;
a flange extending from the supporting portion and surrounding a second chamber, the first chamber and the second chamber connected to each other to form a space inside the supporting structure; and
an aperture for communicating the space and outside of the supporting structure.

2. The supporting structure according to claim 1, wherein the aperture is located at the supporting portion for communicating the first chamber and the outside of the supporting structure.

3. The supporting structure according to claim 1, wherein the aperture is located at the flange for communicating the second chamber and the outside of the supporting structure.

4. The supporting structure according to claim 1, wherein the aperture is located at a lower edge of the supporting structure.

5. A projecting device comprising:
a lamp;
a supporting structure comprising:
a supporting portion covering the lamp, a first chamber formed inside the supporting portion, the supporting portion having a first sidewall and a second sidewall, an entry and an exit disposed respectively on the first sidewall and the second sidewall;
a flange extending from the supporting portion and surrounding a second chamber, the first chamber and the second chamber connected to each other to form a space inside the supporting structure; and
an aperture for communicating the space and outside of the supporting structure; and
a fan for generating airflow running through the entry and the exit.

6. The projecting device according to claim 5, wherein the aperture is located at the supporting portion for communicating the first chamber and the outside of the supporting structure.

7. The projecting device according to claim 5, wherein the aperture is located at the flange for communicating the second chamber and the outside of the outer space.

8. The projecting device according to claim 5, wherein the aperture is located on a lower portion of the supporting structure.

9. The projecting device according to claim 5, wherein the projection device is a projector or a projection television.
